(19) United States
(12) Patent Application Publication
(10) Pub. No.: US 2009/0022034 A1
(43) Pub. Date: Jan. 22, 2009

(54) OPTICAL HEAD DEVICE AND METHOD OF ADJUSTING CHARACTERISTIC OF OPTICAL HEAD DEVICE

(75) Inventors: Yuuichi TAKEI, Nagano (JP); Katsuyoshi MIYASAKA, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 12/140,166

(22) Filed: Jun. 16, 2008

(30) Foreign Application Priority Data
Jun. 14, 2007 (JP) JP2007-157775

(51) Int. Cl. G11B 7/095

(52) U.S. Cl. 369/112.01

(57) ABSTRACT

In an optical head device having a laser light source, an output adjusting member for adjusting the output of laser light emitted from the laser light source and a frame for supporting the laser light source and the output adjusting member, the output adjusting member has an adjusting circuit board for adjusting an electrical resistance value, and a plurality of circuits on which chip resistors and short lands are connected to one another in parallel are connected in series.

This application claims priority under 35 U.S.C. 119 to Japanese application JP 2007-157775 filed Jun. 14, 2007, the entire contents of which are incorporated herein by reference.

### BACKGROUND OF THE INVENTION

1. Field of the Invention

The present invention relates to an optical head device and a method of adjusting the characteristic of the optical head device, and particularly to an optical head device that can lead laser light emitted from a laser light source to an optical recording medium and also receive reflection laser light from the optical recording medium, and a method of adjusting the characteristic of the optical head device to adjust the output of laser light emitted (the emitted laser beam intensity) from the laser light source.

2. Description of the Related Art

In some cases, an optical head device is used as a device for recording/reproducing information in a disc-shaped optical recording medium such as a compact disc (hereinafter referred to as “CD”), a digital versatile disc (hereinafter referred to as “DVD”) or the like.

Such an optical head device generally has a laser light source, an optical system, an objective lens, a lens holder, a lens driving unit, a frame body and other predetermined members.

The laser light source can emit recording laser light or reproducing laser light to an optical recording medium. The optical system constitutes an optical path through which the laser light emitted from the laser light source is led to the optical recording medium. The objective lens irradiates the optical recording medium with the laser light led by the optical system. The lens holder holds the objective lens. The lens driving unit can drive the lens holder in a focusing direction and a tracking direction. The frame body accommodates a fabrication comprising the above members (so-called optical pickup module) therein.

A variable resistor may be used to adjust the characteristic of the optical head device such as the intensity or the like of the laser light emitted from the laser light source (see JP-A-2004-342278) i.e., the laser light intensity or output level. This variable resistor has a rotational shaft, and the resistance value thereof can be varied/adjusted by adjusting the rotational angle of the rotational shaft. This variable resistor is generally mounted on a circuit board, and the circuit board is fixed to the frame body of the optical head device.

Recently, miniaturization, weight saving and reduction in thickness have been advanced. Therefore, when circuit boards each having a variable resistor mounted thereon are simply stacked and disposed in the thickness direction of the frame (the plane direction of the circuit board is set along the thickness direction of the frame), the thickness dimension of the optical head device is larger by the amount corresponding to the thickness of the circuit board. That is, restriction is applied to the reduction in thickness.

Therefore, in the construction that the circuit boards are stacked and disposed in the thickness direction of the frame, when the circuit boards are disposed within the thickness of the frame, it is necessary that a predetermined place of the frame is recessed and the circuit board is mounted in the recess portion concerned. In such a construction, the place at which the recess portion is formed is smaller in the thickness of the frame as compared with the other places, and thus the rigidity of the frame is reduced as a whole.

Furthermore, in order to prevent variation of the resistance value of the variable resistor due to a positional displacement after the adjustment, an adjusting screw is fixedly supported. Accordingly, when the variable resistor which is mounted on the circuit board and fixed to the frame is adjusted, large force may be applied to the frame and the frame may become distorted. If the frame becomes distorted, positional displacement of the optical element fixed to the frame may occur.

There is also considered such a construction that a circuit board having a variable resistor mounted thereon is disposed on the side surface of the frame. However, in the optical head device, a main shaft and an auxiliary shaft are provided along the rotational direction of the optical recording medium, and thus restriction may be applied to the size in the thickness direction of the frame rather than the size of the fitting portion of the adjusting screw to which an adjusting jig is fitted.

### SUMMARY OF THE INVENTION

At least an embodiment of the present invention provides an optical head device having an optical characteristic adjusting mechanism in which a frame can be avoided from being distorted due to application of large force to the frame when the output of emitted laser light is adjusted, and particularly to provide an optical head device having an optical characteristic adjusting mechanism that can be avoided from being distorted due to application of large force to the frame in an operation of adjusting the output of emitted laser light even when the optical head device is designed to be compact or thin, or an optical head device having an optical characteristic adjusting mechanism which can be easily produced at low price or does not increase the price thereof.

According to at least an embodiment of the present invention, in an optical head device including a laser light source, an output adjusting member for adjusting the output of laser light emitted (the emitted laser beam) from the laser light source and a frame for supporting the laser light source and the output adjusting member, the output adjusting member has a circuit board on which a plurality of circuits each comprising short lands and chip resistors which are connected in parallel are connected to one another in series.

Here, it is preferable that the frame has a frame portion in which an objective lens for focusing the emitted laser beam to the optical recording medium and an objective lens driving mechanism for driving the objective lens are accommodated, and a fixing portion to which the output adjusting member is fixed.

According to the above construction, the objective lens driving mechanism can be mounted in the frame portion of the frame, and thus the optical head device can be designed to be thin. In addition, when the frame is designed as the frame portion, the rigidity thereof is lowered, however, no large force is applied to the frame in connection with the adjustment of the output of the emission laser beam, and thus there is no risk that the frame is distorted. Accordingly, there is no risk that the optical element fixed to the frame is positionally displaced and the optical axis of the optical system is displaced.

Furthermore, it is preferable that the frame comprises a metal frame containing an optical element constituting at least one of a going path through which laser light emitted from the laser light source is led to the optical recording medium and a returning path through which reflection light from the optical recording medium is led to a photodetecting element, and a resin frame forming a frame body in which the metal frame is accommodated, and the output adjusting member is fixed to the resin frame.

According to the above construction, a part of the frame may be formed of resin, whereby the weight of the optical head device can be reduced. In addition, the metal frame having the optical element mounted thereon can be accommodated in the frame portion, so that the thickness of the optical head device can be reduced. Furthermore, the frame is formed of resin and also designed as a frame portion, whereby no large force is applied to the frame in connection with the adjustment of the output of the emitted laser light and thus the frame is not distorted although the rigidity is lowered. Accordingly, there is no risk that the positional displacement of the optical element fixed to the frame and the displacement of the optical axis of the optical system occur.

According to at least an embodiment of the present invention, a method of adjusting the characteristic of the optical head device comprising: determining one or more of the plural series-connected short lands in accordance with the output of the emitted laser light from the laser light source; and short-circuiting the determined one or more short lands.

According to at least an embodiment of the present invention, in the output adjusting member, plural circuits each of which has short lands and chip resistors are connected to one another in parallel are connected to one another in series on the circuit board. That is, a predetermined number of chip resistors are mounted on the circuit board, and also short lands are formed in parallel to the respective chip resistors on the circuit board. As compared with a case where the output of the emission laser is adjusted by using a volume, it is unnecessary to apply large force to the frame, and thus there is no risk that the frame is distorted or deformed. Accordingly, there is no risk that an optical element fixed to the frame is positionally displaced and the optical axis of an optical system is displaced.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an equivalent circuit of a characteristic adjusting circuit board provided to an output adjusting member installed in an optical head device according to at least an embodiment of the present invention;

FIG. 2 is a perspective view showing the outlook of the construction of the optical head device according to at least a first embodiment of the present invention, and shows the construction that the adjusting circuit board is disposed along the thickness direction;

FIG. 3 is a plan view showing the construction of the optical head device according to at least a second embodiment of the present invention, and shows the construction that the adjusting circuit board is disposed along the side surface;

FIG. 4 is a perspective view showing an optical system of the optical head device according to at least an embodiment of the present invention;

FIG. 5 is an exploded perspective view showing a main frame (resin frame) and a sub frame (metal frame) of an optical head device according to at least a third embodiment of the present invention;

FIGS. 6(a) and 6(b) are exploded perspective views showing the optical head device according to at least the third embodiment of the present invention when the main frame (resin frame) to which only the sub frame (metal frame) is fixed is viewed from different directions;

FIG. 7 is a perspective view showing the outlook of the construction of an objective lens driving mechanism of the optical head device according to at least an embodiment of the present invention;

FIG. 8 is a plan view showing the construction of an optical head device according to at least a third embodiment of the present invention;

FIGS. 9(a) to 9(e) are enlarged views of the main part of a flexible printed circuit board in the optical head device shown in FIG. 8 when a part of the flexible printed circuit board is removed, wherein FIG. 9 (a) is a plan view, FIG. 9(b) is a bottom view, FIG. 9(c) is a left side view, FIG. 9(d) is a right side view and FIG. 9(e) is a cross-sectional view of O-O in FIG. 9(b);

FIG. 10 is a plan view showing the optical head device 2 of FIGS. 9(a) to 9(e) when an upper cover, a lower cover and an actuator cover are detached from the main part of the optical head device 2;

FIG. 11 is a bottom view of FIG. 10; and

FIG. 12 is a cross-sectional view taken along N-N line of FIG. 10.

### DETAILED DESCRIPTION OF THE PREFERRED EMBODIMENTS

Preferred embodiments according to the present invention will be described hereunder with reference to the accompanying drawings.

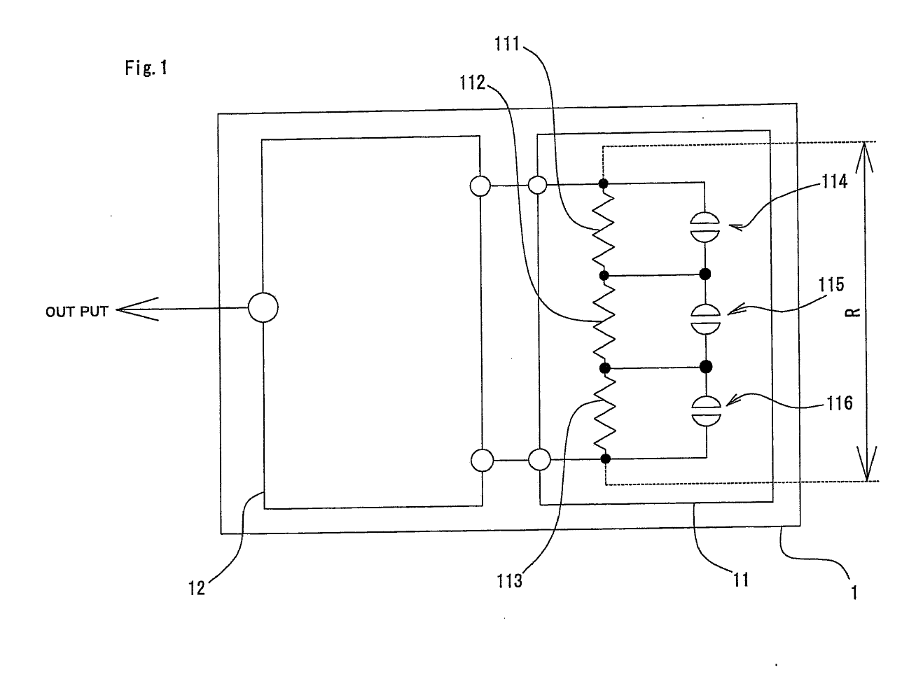

FIG. 1 is a diagram showing the equivalent circuit of a characteristic adjusting circuit board (hereinafter referred to as “adjusting circuit board 11”) provided to an output adjusting member 1 installed in an optical head device 2 according to at least an embodiment of the present invention.

As shown in FIG. 1, plural resistors are provided on the adjusting circuit board 11, and these plural resistors (three chip resistors of a first chip resistor 111, a second chip resistor 112 and a third chip resistor 113 in FIG. 1) are connected to one another in series. Furthermore, short lands (three short lands of a first short land 114, a second short land 115 and a third short land 116 in FIG. 1) are connected to the first, second and third chip resistors 114, 115 and 116, respectively in parallel. In other words, the parallel circuits each of which comprises one resistor and one short land are connected to one another in series.

An inexpensive chip resistor having a fixed resistance value is applied to each of the plural resistors 111, 112, 113 mounted on the adjusting circuit board 11. The resistance values of the respective chip resistors 111, 112, 113 and the number of the chip resistors 111, 112, 113 are not limited to specific values. In short, the total of the resistance values of the mounted chip resistors 111, 112, 113 (the total resistance value when the respective chip resistors are connected to one another in series) may be set so as to be larger than the maximum resistance value in a desired adjustment range. The resistance values of the chip resistors 111, 112, 113 will be described later.

The “short land” in at least an embodiment of the present invention is defined as a structure comprising a pair of lands which are provided to be very close to each other and are not electrically connected to each other under a normal state, but can be easily electrically connected to each other by soldering or bringing a probe into contact with the lands (in this case, two lands a repaired). In this case, the structure is not limited to “the lands” insofar as it can be easily electrically connected by soldering or contact of a probe.

In short, any structure is referred to as “short land” in at least an embodiment of the present invention insofar as it can be easily electrically connected by soldering or contact of a probe (or the structure is formed on the basis of the above intention). At least an embodiment of the present invention is constructed so as to contain tips of two wires constituting a pair physically close to each other.

The paired two lands constituting the short land are not physically connected to each other under a normal state, and thus are not electrically connected to each other. The paired two lands are electrically connected to each other by soldering the lands or bringing a probe into contact with the lands so as to bridge the lands.

Accordingly, the resistance R between both the ends of the adjusting circuit formed on the adjusting circuit board 11 can be set to values in the following cases when the resistance value of the first chip resistor 111 is represented by r₁, the resistance value of the second chip resistor 112 is represented by r₂ and the resistance value of the third chip resistor 113 is represented by r₃ in the construction having the three chip resistors 111, 112, 113 as shown in FIG. 1.

First Case

When each of the short lands 114, 115 and 116 which are provided in parallel to the first, second and third chip resistors 111, 112 and 113 respectively is not electrically connected (i.e., short-circuited), the resistance R between both the ends of the adjusting circuit is equal to r₁+r₂+r₃.

Second Case

When the first short land 114 provided in parallel to the first chip resistor 111 is electrically short-circuited by soldering or the like and the second and third short lands provided in parallel to the second and third chip resistors 112 and 113 respectively are not electrically connected, the resistance R between both the ends of the adjusting circuit is equal to r₂+r₃. Wires which are located between the short lands and extend to the short lands have inherent resistance values, however, they can be neglected as compared with the resistance values of the respective chip resistors 111, 112, 113. Accordingly, these resistance values are neglected (the same is applied to the following cases).

Third Case

When the first and second short lands 114, 115 provided in parallel to the first and second chip resistors 111, 112 respectively are electrically connected (short-circuited) and the third short land 116 provided in parallel to the third chip resistor 113 is not electrically connected (short-circuited), the resistance R between both the ends of the adjusting circuit is equal to r₃.

Fourth Case

When all of the first to third short lands 114, 115, 116 provided in parallel to the first, second and third chip resistors 111, 112 and 113 respectively are electrically connected (short-circuited), the resistance R between both the ends of the adjusting circuit is substantially equal to zero (or negligible small).

Assuming that all the resistance values r₁, r₂, r₃ of the respective chip resistors 111, 112, 113 are equal to the same resistance value rₐ, the resistance R between both the ends of the adjusting circuit can be linearly changed to four stages of substantially zero (or negligible small resistance value), rₐ, 2rₐ, 3rₐ. When all the resistance values of the respective chip resistors 111, 112, 113 are equal to one another, the resistance R between both the ends of the adjusting circuit is determined by only the number of the electrically-connected (short-circuited) short lands 114, 115, 116, and it is irrelevant to which short lands 114, 115, 116 are electrically connected (short-circuited). Accordingly, the short lands 114, 115, 116 to be connected (short-circuited) to obtain a desired resistance value are not limited to the above cases.

When all the resistance values r₁, r₂, r₃ of the respective chip resistors 111, 112, 113 are different from one another, the resistance R between both the ends of the adjusting circuit can be set as follows in addition to the above first to fourth cases.

Fifth Case

When the second short land 115 provided in parallel to the second chip resistor 112 is electrically connected (short-circuited) and the first and third short lands 114 and 116 provided in parallel to the first and third chip resistors 111 and 113 respectively are not electrically connected (short-circuited), the resistance R between both the ends of the adjusting circuit is equal to r₁+r₃.

Sixth Case

When the third short land 116 provided in parallel to the third chip resistor 113 is electrically connected (short-circuited) and the first and second short lands 114 and 115 provided in parallel to the first and second chip resistors 111 and 112 respectively are not electrically connected (short-circuited), the resistance R between both the ends of the adjusting circuit is equal to r₁+r₂.

Seventh Case

When the first and third short lands 114 and 116 provided in parallel to the first and third chip resistors 111 and 113 are electrically connected (short-circuited) and the second short land 114 provided in parallel to the second chip resistor 112 is not electrically connected (short-circuited), the resistance R between both the ends of the adjusting circuit is equal to r₂.

Eighth Case

When the second short land 115 and the third short land 116 provided in parallel to the second and third chip resistors 112 and 113 are electrically connected (short-circuited) and the first short land 114 provided in parallel to the first chip resistor 111 is not electrically connected (short-circuited), the resistance R between both the ends of the adjusting circuit is equal to r₁.

Accordingly, when the resistance values r₁, r₂, r₃ of the first to third chip resistors 111, 112, 113 are different from one another, the resistance R between both the ends of the adjusting circuit can be set to eight kinds of substantially zero (or negligible small value) (fourth case), r₁ (eighth case), r₂ (seventh case), r₃ (third case), r₁+r₂ (sixth case), r₁+r₃ (fifth case), r₂+r₃ (second case) and r₁+r₂+r₃ (first case).

Specifically, when a chip resistor whose resistance value is twice as large as the resistance value of the first chip resistor 111 is applied to the second chip resistor 112 (that is, r₂=2r₁) and a chip resistor whose resistance value is four times as large as the resistance value of the first chip resistor 111 is applied to the third chip resistor 113 (that is, r₃=4r₁), the resistance R between both the ends of the adjusting circuit can be set to any one of the following eight kinds of resistance values.

That is, the resistance R can be set to any one of eight kinds of resistance values: R≈0 (fourth case), R=r₁ (eight case), R=2r₁ (seventh case), R=3r₁ (sixth case), R=4r₁ (third case), R=5r₁ (fifth case), R=6r₁ (second case) and R=7r₁ (first case).

As described above, when (the resistance value r₁ of the first chip resistor):(the resistance value r₂ of the second chip resistor):(the resistance value r₃ of the third chip resistor)=1:2:4, the whole resistance value can be selectively set from the resistance values at seven substantially equally spaced stages by the three chip resistors 111, 112, 113. Accordingly, fine adjustment of the resistance value can be accurately and easily performed.

In addition, when a chip resistor whose resistance value is twice as large as the resistance value of the first chip resistor 111 is applied to the second chip resistor 112 (that is, r₂=2r₁) and a chip resistor whose resistance value is five times as large as the resistance value of the first chip resistor 111 is applied to the third chip resistor 113 (that is, r₃=5r₁), the resistance R between both the ends of the adjusting circuit can be set to any one of the following eight kinds of the resistance values.

That is, the resistance value can be set to any one of eight kinds of resistance values of R≈0 (fourth case), R=r₁ (eight case), R=2r₁ (seventh case), R=3r₁ (sixth case), R=5r₁ (third case), R=6r₁ (fifth case), R=7r₁ (second case) and R=8r₁ (first case).

As described above, when (the resistance value r₁ of the first chip resistor 111):(the resistance value r₂ of the second chip resistor 112):(the resistance value r₃ of the third chip resistor 113)=1:2:5, the total resistance value can be properly selected from the eight kinds of resistance values: which are zero time, once (equal), twice, three times, five times, six times, seven times and eight times of the resistance value of the chip resistor having the minimum resistance value (in this case, the resistance value r₁ of the first chip resistor 111). Accordingly, the fine adjustment of the resistance value can be accurately and easily performed. The total resistance value cannot be set to the resistance value which is four times as large as r₁, however, the upper limit of the settable range is equal to eight times, so that the settable range of the resistance value can be expanded.

According to the above construction, a desired number (three in this embodiment) of chip resistors 111, 112, 113 and short lands 114, 115, 116 whose number is equal to the number of the chip resistors 111, 112, 113 are merely mounted on the adjusting circuit board 11. Accordingly, as compared with a circuit board on which a variable resistor (for embodiment, a rotational type variable resistor) is mounted, the size of the circuit board can be greatly miniaturized. Furthermore, the chip resistor is thinner than the variable resistor, and thus the adjusting circuit board 11 on which the chip resistors are mounted can be thinned as a whole as compared with the circuit board on which the variable resistor is mounted. As described above, the fine adjusting circuit board 11 can be easily designed to be compact and thin.

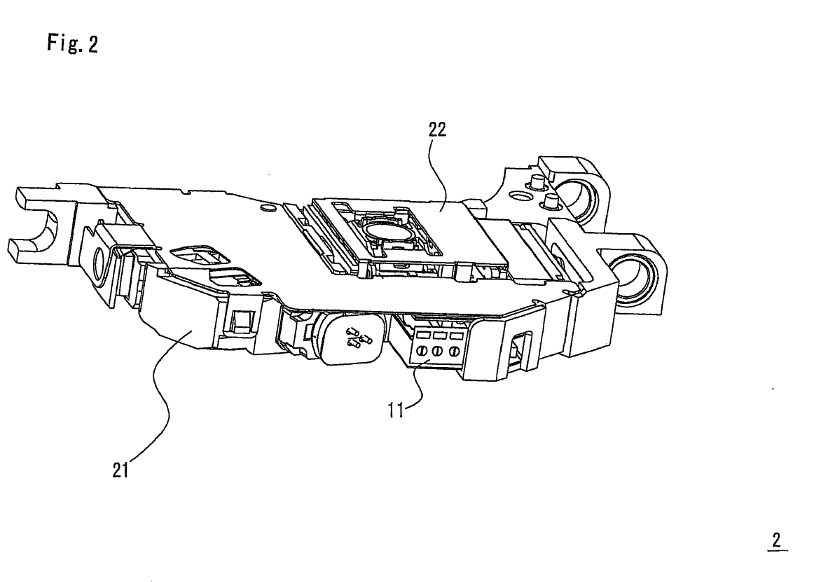

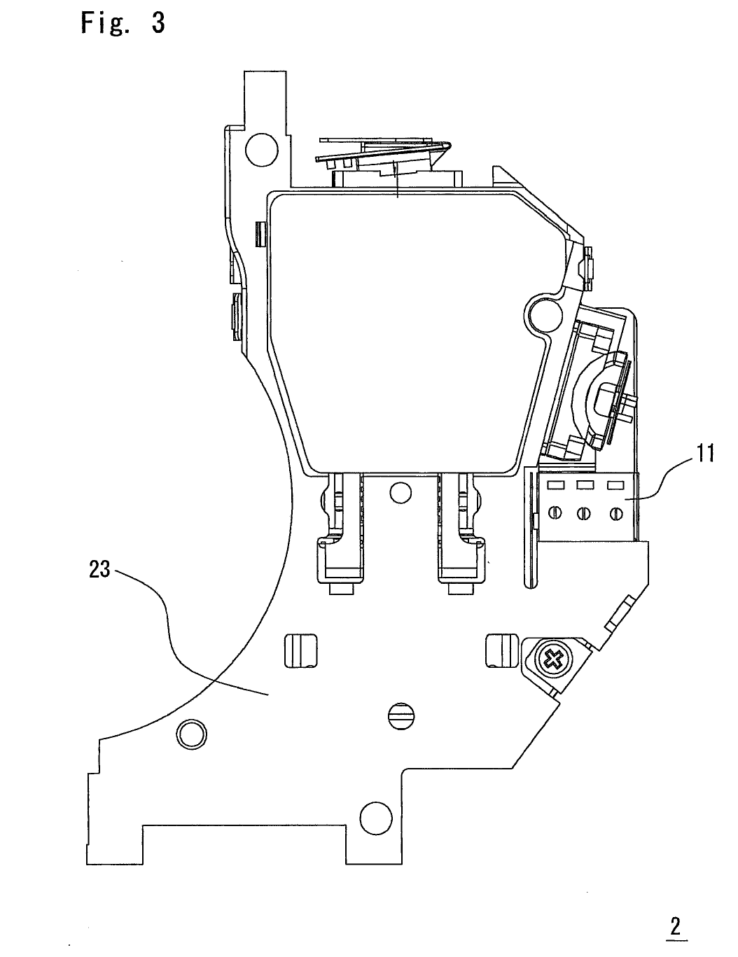

FIG. 2 is a perspective view showing the outlook of the construction of the optical head device 2 according to at least a first embodiment of the present invention, shows the construction that the adjusting circuit board 11 is provided along the thickness direction of the optical head device 2 according to at least an embodiment of the present invention. In the optical head device 2 according to the first embodiment, zinc alloy die-cast or the like is applied to the frame. The fine adjusting circuit 11 is disposed on a frame 23 formed of metal (see FIG. 3). As shown in FIG. 2, even when the adjusting circuit board 11 is disposed along the thickness direction of the optical head, the adjusting circuit board 11 can be designed to be more compact in size as compared with the fitting portion of the adjusting screw of the volume, and thus the adjusting circuit board 11 can be mounted within the height range of the frame, so that the optical head device 2 of at least an embodiment of the present invention can be designed to be thin.

Furthermore, a rotating motor for an optical recording medium is disposed at the inner peripheral side of the frame, and a flexile wire board for inputting/outputting a signal to/from a variable resistor is disposed at the outer peripheral side of the frame. However, the adjusting circuit boards 11 are compact, and thus the adjusting circuit boards 11 can be disposed at any side of the inner peripheral side and the outer peripheral side of the frame without interfering in one another. Accordingly, the degree of freedom of the arrangement of parts on design can be enhanced.

FIG. 3 is a plan view showing the construction of an optical head device 2 according to at least a second embodiment of the present invention, and shows the construction that the adjusting circuit board 11 is provided along the lower surface of the optical head device 2 according to at least an embodiment of the present invention. In the optical head device 2 according to the second embodiment shown in FIG. 3, the frame 23 is formed of metal such as zinc alloy die-cast or the like, and the adjusting circuit board 11 is disposed on the frame.

As shown in FIG. 3, in the construction that the adjusting circuit boards 11 are disposed along the lower surface of the frame, that is, the adjusting circuit boards 11 are stacked and disposed in the thickness direction of the frame, a recess portion is formed at a predetermined place of the lower surface of the frame, and the adjusting circuit boards 11 are disposed in the recess portion. In this case, as compared with the circuit board having the variable resistor mounted thereon, the size of the adjusting circuit board 11 is smaller, and thus the size of the recess portion formed in the frame can be reduced. Furthermore, the thickness of the chip resistor is thinner than the variable resistor and thus the depth of the recess portion can be made smaller.

Accordingly, the reduction of the rigidity of the frame at the recess portion can be prevented or suppressed. Since the local reduction of the rigidity of the frame can be prevented or suppressed, so that the distortion of the optical head device due to temperature variation of the environment under which the device is used, or the displacement of the optical axis due to the distortion can be prevented.

Furthermore, as described above, the adjusting screw is firmly mounted in the variable resistor to prevent variation of the resistance value due to positional displacement after adjustment. Therefore, when the variable resistor which is mounted on the adjusting circuit board 11 and fixed to the frame is adjusted, large force may be applied to the frame and thus there is a risk that the frame is distorted. On the other hand, according to at least an embodiment of the present invention, the resistance value is adjusted by soldering the connection lands. Accordingly, unlike the construction using the variable resistor, it is unnecessary to apply large force to the board and the frame for supporting the board. Accordingly, there is no risk that the frame is distorted.

The adjustment screw of the variable resistor is firmly supported, however, there is a risk that the adjusting screw is moved due to the contact between the adjusting screw and an external member after the adjustment. However, in at least an embodiment of the present invention, the resistance value is adjusted by soldering the short lands, and the adjusted resistance value does not vary even in the case of the contact of some member from the outside. Accordingly, the adjustment can be performed with high reliability.

Furthermore, the adjusting circuit board 11 can be designed to be compact, and thus the degree of freedom of the disposing place can be enhanced.

Furthermore, as described above, the adjustable range of the resistance is expanded, however, the variation of the resistance per rotational angle of the shaft for adjustment increases as the adjustable resistance value range expands. Therefore, when a variable resistor having a large adjustable range is applied, it is difficult to finely adjust the resistance. On the other hand, according to at least an embodiment of the present invention, the resistance value can be accurately stepwise finely adjusted by properly selecting the resistance values of the chip resistors mounted on the adjusting circuit board 11. Likewise, the adjustable range can be expanded by properly selecting the resistance value of the plural chip resistors 111, 112, 113 mounted on the adjustable circuit board 11.

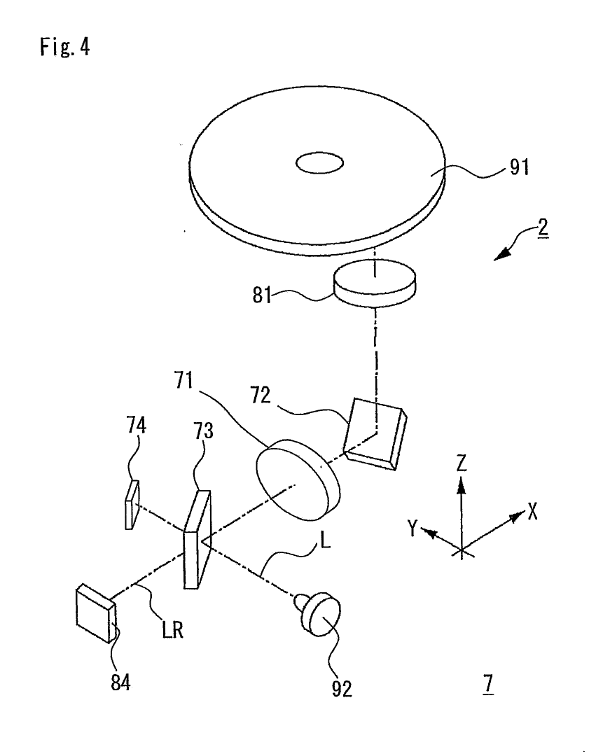

Next, the optical head device 2 according to at least an embodiment of the present invention, that is, the optical head device 2 having the adjusting circuit board 11 will be described. FIG. 4 is a diagram showing the construction of an optical system 7 of the optical head device 2 according to at least an embodiment of the present invention.

As shown in FIG. 4, the optical head device 2 according to at least an embodiment of the present invention reproduces and records information into/from an optical recording medium 91 such as CD, DVD or the like, and it has a laser light emitting element 92 as a light source, a signal-detecting light receiving element 84 for detecting a signal, an optical system constituting a going path for leading laser light emitted from the laser light emitting element 92 to an objective lens 81 and a returning path for leading laser light from the objective lens 81 to the signal detecting light receiving element 84, and the objective lens 81 (the “objective lens” may be classified to be contained in the “optical system”).

As shown in FIG. 4, the optical system is constructed by a half mirror 73, a collimate lens 71, a total reflection mirror 72, etc. The half mirror 73 has a function as an optical path separating element for reflecting laser light L emitted from the laser light emitting element 92 in a Y-axis direction to an X-axis direction. The collimate lens 71 has a function of collimating laser light from the half mirror 73. The total reflection mirror 72 has a function of vertically-deflecting the laser light L in a z-axis direction. The object lens 81 has a function of focusing laser light vertically-deflected by the total reflection mirror 72 onto the recording face of the optical recording medium 91.

Furthermore, in the optical system, the laser light L irradiated to and reflected from the optical recording medium 91 travels in the reverse direction to the optical path LR (going path), passes through the half mirror 73 and reaches the signal detecting light receiving element 84. The laser light L is received and detected by the signal detecting light receiving element 84 (this optical path is “returning path”).

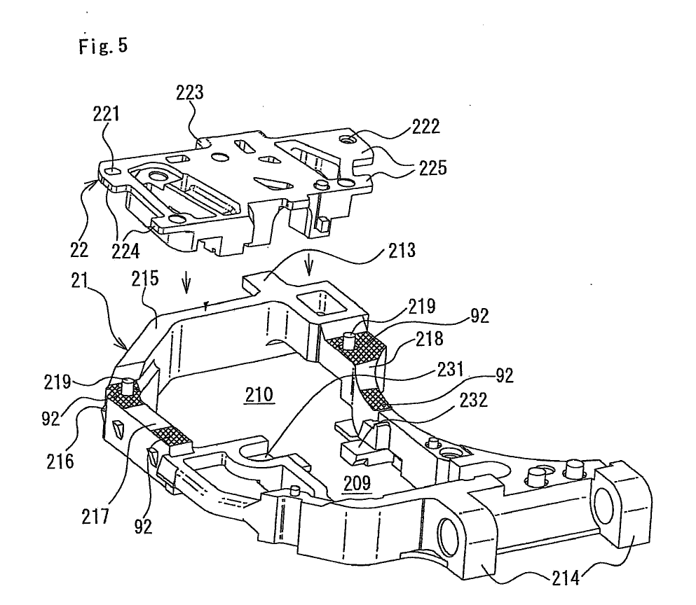

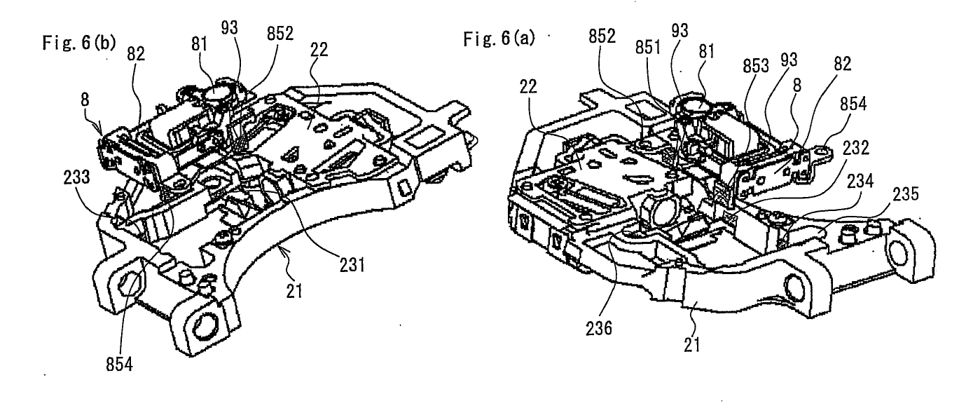

FIG. 5 is an exploded perspective view showing a main frame 21 (that is, resin frame) and a sub frame 22 (that is, metal frame) of the optical head device 2 according to at least the third embodiment of the present invention. FIGS. 6(a) and 6(b) are exploded perspective views showing the main frame 21 to which the sub frame 22 is attached.

As shown in FIG. 5, the optical head device 2 according to at least the third embodiment of the present invention has the main frame 21 (resin frame) and the sub frame 22 (metal frame). The main frame 21 (resin frame) is a frame-shaped member which is formed of resin material and designed so that first and second bearing portions 213, 214 for supporting a main shaft and an auxiliary shaft (not shown) are formed at both the end portions thereof. The sub frame 22 (metal frame) is fitted to a sub frame mount area 210 formed in the frame of the main frame 21 (resin frame), and at least some of plural optical members constituting the optical system are mounted there.

The main frame 21 (resin frame) is provided with an objective lens driving mechanism mount area 209 for an objective lens driving mechanism 8, and the objective lens driving mechanism 8 which supports the objective lens 81 so that the objective lens 81 can be driven (moved) is mounted in the objective lens driving mechanism mount area 209. As shown in FIG. 5, a first bearing portion 213 for supporting a guide shaft (so-called auxiliary shaft) (not shown) of an optical recording medium driving device (not shown) and a second bearing portion 214 for supporting a guide shaft (so-called main shaft) are formed in the main frame 21 (resin frame). The optical head device 2 is designed so as to be driven (moved) in the radial direction of the optical recording medium 91. In the main frame 21 (resin frame), the sub frame mount area 210 is formed at the first bearing portion 213 side, and the objective lens driving mechanism mount area 209 is formed at the second bearing portion 214 side.

A first sub frame joint area 217 and an end portion area 215 are formed so as to surround the sub frame amount area 210 in the main frame 21 (resin frame). Positioning projections 219 for the sub frame 22 (metal frame) are provided in the first and second sub frame joint areas 217 and 218, respectively. The first sub frame joint area 217 is formed so as to be bent from the end portion of a slope portion of the end area 215 which is located at the first bearing portion 213 side and adjacent to the first bearing portion 213. Furthermore, the second sub frame joint area 218 is formed at a switching portion between a slope portion at the end portion of the end area 215 and an arcuate bent portion.

As shown in FIG. 5, the sub frame 22 (metal frame) is a member which is formed in a substantially rectangular planar shape. In FIG. 5, the upper surface side of the sub frame 22 is formed to be flat as a whole, and the lower surface side is formed so that a rib, an uneven portion, etc. for positioning the respective optical elements are formed. Plate-shaped first and second joint portions 224 and 225 are formed in the sub frame 22 (metal frame) so as to extend from the upper surface side to both the right and left sides. An elongated through hole 221 is formed in the first joint portion 224, and a through hole 222 having a circular-hole shape is formed in the second joint portion 225. The positioning projections 219 of the main frame 21 (resin frame) can be fitted in these through holes 221 and 222.

The main frame (resin frame) is formed of resin. The sub frame 22 (metal frame) is formed of metal, and for example a zinc alloy die cast product or the like is applied as the sub frame 22. The sub frame 22 (metal frame) is held under the state that it is disposed in the sub frame mount area 210 inside the main frame 21 (resin frame). The first joint portion 224 and the second joint portion 225 of the sub frame 22 (metal frame) are mounted and fixed onto the first sub frame joint area 217 and the second sub frame joint area 218 of the main frame 21 (resin frame) from the upper side of FIG. 5.

For example, the first joint portion 224 and the second joint portion 225 formed at the open end portions of the sub frame 22 (metal frame) are fixed to the first sub frame joint area 217 and the second sub frame joint area 218 of the main frame 21 (resin frame) respectively by adhesive agent.

At this time, the positioning projections 219 of the main frame 21 (resin frame) are fitted in the through hole 221 of the first joint portion 224 and the through hole 222 of the second joint portion 225. The position of the sub frame 22 (metal frame) is adjusted with in the range of the elongated hole 221 of the through hole 222, thereby positioning the sub frame 22 (metal frame).

The adhesive agent is hardened under the state that it exists between the first sub frame joint area 217 and the first joint portion 224 and between the second sub frame joint area 218 and the second joint portion 225. Therefore, the first sub frame joint area 217 and the second sub frame joint area 218 are adhesively brought into surface contact with the first joint portion 224 and the second joint portion 225 respectively.

The objective lens driving mechanism 8 is mounted in the objective lens driving mechanism mount area 209 of the main frame 21 (resin frame).

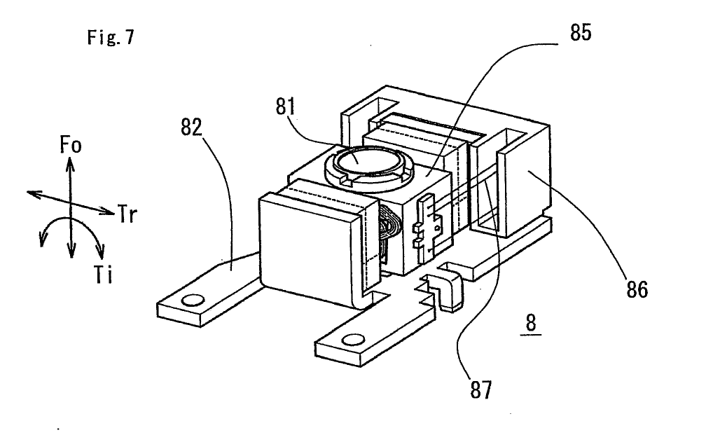

FIG. 7 shows the perspective view of the outlook of the construction of the objective lens driving mechanism 8. The objective lens driving mechanism 8 supports the objective lens 81 so that the objective lens 81 can be driven (moved). That is, the positions in the tracking direction Tr and Ti and the focusing direction Fo of the objective lens 81 is subjected to servo control by the objective lens driving mechanism 8.

In at least an embodiment of the present invention, a well-known wire suspension type is applied as the objective lens driving mechanism 8. Accordingly, the detailed description of the objective lens driving mechanism 8 is omitted.

Outlining briefly, the objective lens driving mechanism 8 has a lens holder 85, a holder supporter 86 and a yoke 82. The lens holder 85 holds the objective lens 81. The holder supporter 86 supports the lens holder 85 by plural wires 87 so that the lens holder 85 are movable in the tracking direction Tr and Ti and the focusing direction Fo. The yoke is fixed to the main frame.

Adhesive portions 851, 852, 853, 854 to be adhesively fixed to predetermined positions of the main frame 21 are formed on the yoke 82 of the objective lens driving mechanism 8. Furthermore, in the main frame 21, fixing portions 231, 232, 233, 234, 235, 236 are provided on the inner wall of the frame member as shown in FIGS. 6(a) and 6(b). The adhesive portions of the objective lens driving mechanism 8 are disposed so as to face the fixing portions 231, 232, 233, 234 through predetermined intervals, and adhesive agent is coated in predetermined gaps 92 between the confronting surfaces thereof, whereby the adhesive portions and the fixing portions are adhesively fixed to one another.

That is, both the adhesive portion 851 and the fixing portion 231, both the adhesive portion 852 and the fixing portion 232, both the adhesive portion 853 and the fixing portion 233 and both the adhesive portion 854 and the fixing portion 234 are respectively disposed so as to face each other through a predetermined gap without coming into surface-contact with each other. Adhesive agent is filled in these predetermined gaps 92 to thereby fix the above elements.

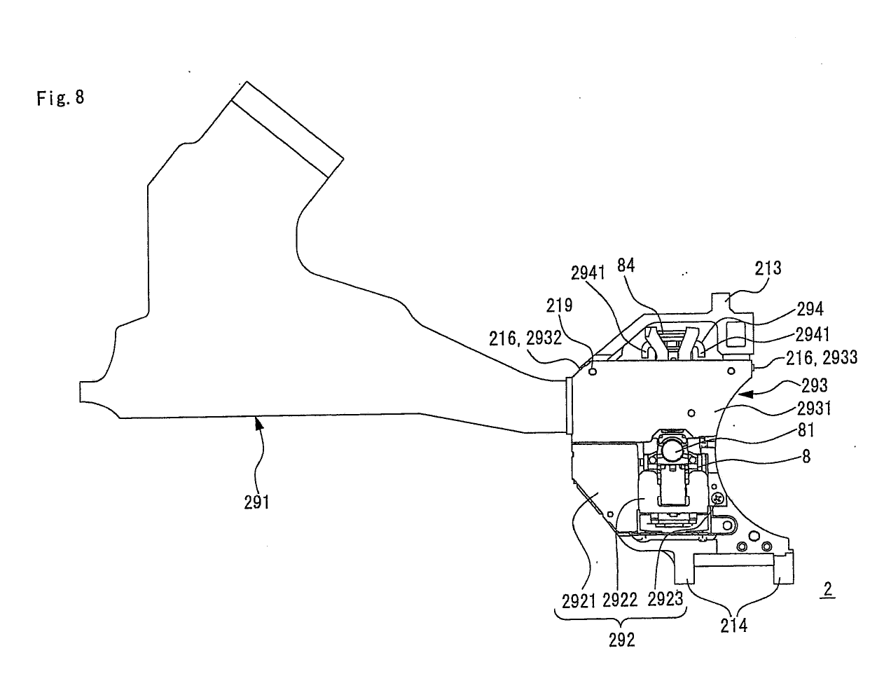

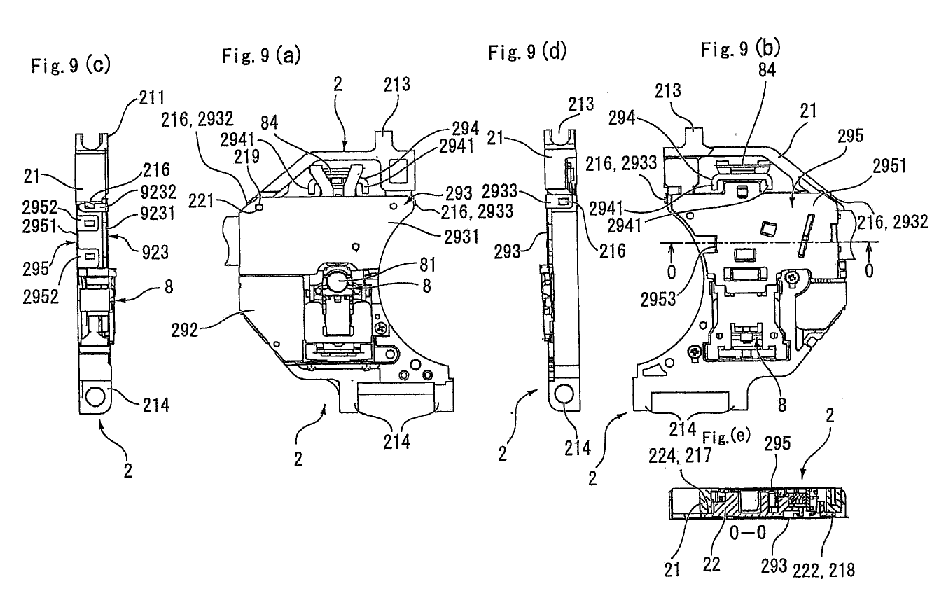

FIG. 8 is a plan view showing an example of an optical head device 2 according to at least a third embodiment of the present invention. FIG. 9(a) to 9(e) are diagrams showing the optical head device 2 shown in FIG. 8 when a part of a flexible printed circuit board 291 is removed from the optical head device 2 and the main body part of the optical head device 2 is enlarged, wherein FIG. 9(a) is a plan view, FIG. 9(b) is a bottom view, FIG. 9(c) is a left side view, FIG. 9(d) is a right side view and FIG. 9(e) is a cross-sectional view of O-O.

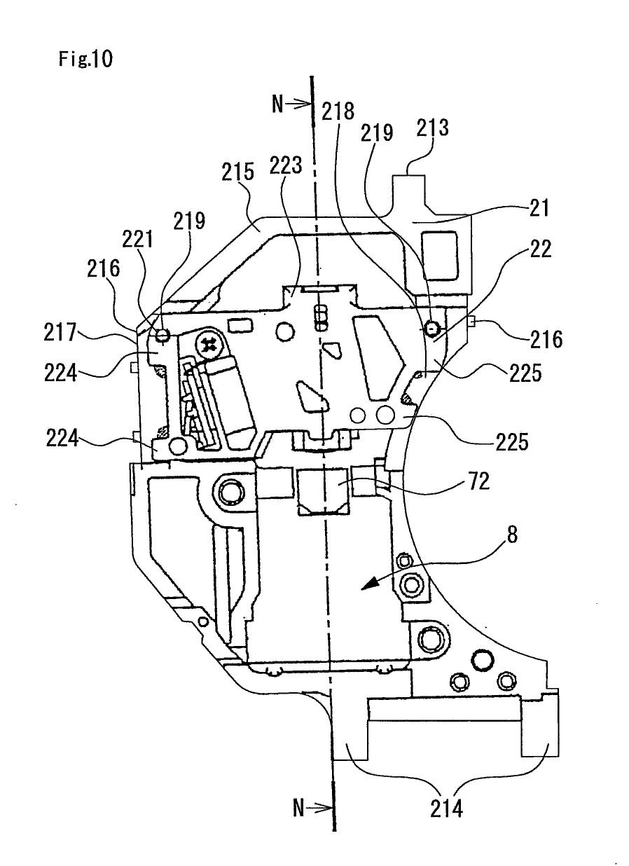

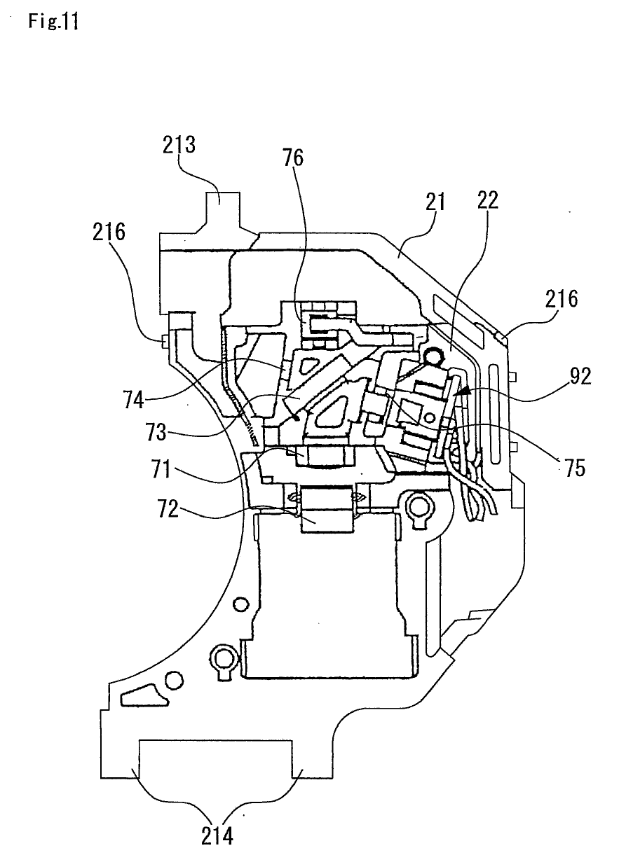

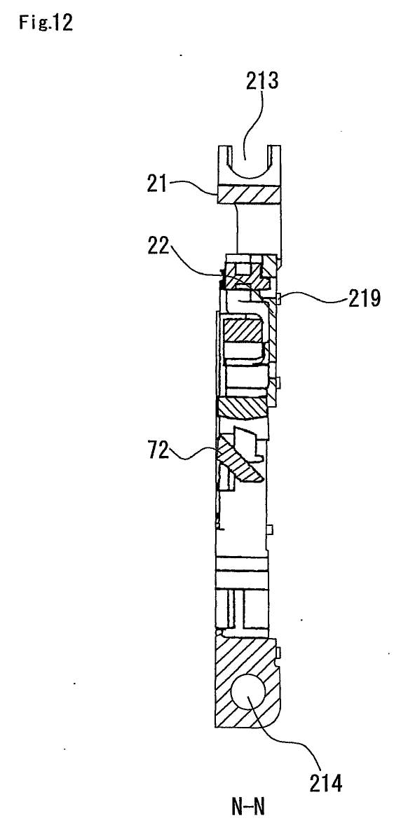

FIG. 10 is a plan view showing a state that an upper cover, a lower cover and an actuator cover are detached from the main part of the optical head device 2 shown in FIG. 9. FIG. 11 is a bottom view of FIG. 10, and FIG. 12 is a cross-sectional view of N-N of FIG. 10.

As shown in FIGS. 8 to 12, in the optical head device 2 according to at least the third embodiment of the present invention, one side surface of the main frame (resin frame) is bent in an arcuate shape so as to prevent interference when it approaches to a spindle motor (not shown) of a disc driving mechanism.

The main body part of a flexible printed circuit board 291 is disposed so as to cover the upper surfaces of the main frame 21 (resin frame) and the sub frame 22 (metal frame) at the lower side of an actuator cover 292 and an upper cover 293. In other words, IC (driving circuit) for driving the laser light emitting element 92 and controlling the objective lens driving mechanism 8, etc. is mounted on the lower surface of the flexible printed circuit board 291. As shown in FIG. 8, the actuator cover 292 has a first upper plate portion 2921, a second upper plate portion 2922 and a fixing plate portion 2923.

The objective lens 81 is located substantially at the center of the main frame 21 (resin frame), and the cover 93 and upper cover 293 are coated on a side of the main frame 21 at which the first bearing portion 213 and first bearing portion sides 211 are located with respect to the objective lens 81. The upper cover 293 has a second upper plate portion 2931, a first side plate portion 2932 fitted to the projection 216 and a second side plate portion 2933 fitted to the projection 216. A lower cover 295 is provided so as to be coated on the bottom surface side of the main frame 21 (resin frame). The lower cover 295 has a lower plate portion 2951, a first side plate portion 2952 and a second side plate portion 2953. The actuator cover 292 is provided so as to be coated on a side of the main frame 21 (resin frame) at which the second bearing portion 214 is located with respect to the objective lens 81.

A driving IC (driving circuit) for controlling the laser light emitting element 92, the objective lens driving mechanism 8, etc. is mounted at the main body part of the flexible printed circuit board 291, and it is disposed so as to cover the upper surface of the main frame 21 (resin frame) at the lower side of the actuator cover 292 and the upper cover 293.

As shown in FIG. 11, the laser light emitting element 92 is mounted in the sub frame 22 (metal frame). The laser light emitting element 92 can generate first laser light (red light) of 650 nm band in wavelength and second laser light (infrared light) of 780 nm band in wavelength. That is, the optical head device 2 is constructed as a dual-wavelength optical head device which can record/reproduce information in/from a DVD type disc and a CD type disc. A twin laser light source having an AlGaInP type laser diode for emitting the first laser light and an AlGaAs type laser diode for emitting the second laser light is applied as the laser light emitting element 92.

The first laser light and the second laser light are led to the optical recording medium 91 through a common optical system comprising plural optical elements 71, 72, 73, 74, 75 and 76 disposed in an optical path directing from the laser light emitting element 92 to the optical recording medium 91. The reflection light from the optical recording medium 91 is led through the common optical system to the signal detecting light-receiving element 84. The common optical system contains optical elements such as a diffraction element 75, a half mirror 73, a collimate lens 71, a sensor lens 76, a total reflection mirror 72 and a objective lens 81.

The diffraction element 75 is mounted on the sub frame 22 (metal frame), and diffracts laser light emitted from the laser light emitting element 92 into three beams for tracking detection. The half mirror 73 is a transmission type optical element through which the laser light from the laser light source 92 is transmitted, and it partially reflects the laser light which is split to three beams by the diffraction element 75. The collimate lens 71 collimates the laser light from the half mirror 83. The total reflection mirror 72 vertically deflects the collimated light to the optical recording medium 91. The objective lens 81 focuses the laser light from the total reflection mirror 72 to the recording face of the optical recording medium 91. The sensor lens 76 provides astigmatism to laser light (return light) which is reflected from the recording face of the optical recording medium and passes through the collimate lens 71 and the half mirror 73.

In the optical system, a front monitor light-receiving element 74 is disposed at the opposite side to the diffraction element 75 with respect to the half mirror 73.

The laser light emitting element 92, the diffraction element 75, the half mirror 73, the collimate lens 71, the sensor lens 76, the signal detecting light-receiving element 84 and the monitor light-receiving element 74 are mounted on the sub frame 22 (metal frame). Furthermore, the sub frame 22 (metal frame) on which the optical elements, etc. are mounted are mounted in the main frame 21 (resin frame). On the other hand, the total reflection mirror 72 is directly mounted on the main frame 21 (resin frame).

As shown in FIG. 5, a projection 223 having an opening formed therein is formed at the end portion of a side of the sub frame 22 (metal frame) at which the first bearing portion of the main frame 21 (resin frame) is located. As shown in FIGS. 9(a) and 9(b), a support board 294 for supporting the signal detecting light-receiving element 84 is adhesively fixed to this projection 223. The signal detecting light-receiving element 84 is mounted substantially at the center of the support board 294 in the length direction thereof. The end portions at both the right and left sides of the support board 2941 are bent so as to pinch the projection 223 from both the sides and fixed to the projection 223 by adhesive agent or the like.

Next, the assembly structure of the optical head device 2 will be described.

The optical elements such as the laser light emitting element 92, the diffraction element 75, the half mirror 73, the sensor lens 76, the collimate lens 71, etc. are mounted at predetermined positions in the sub frame 22. In this step, the signal detecting light-receiving element 84 and the monitor light-receiving element 74 are not mounted in the sub frame 22. Each of the diffraction element 75 and the sensor lens 76 is merely temporarily fixed by a leaf spring. After the angular position of the laser light emitting element 92 and the position of the diffraction element 75 are adjusted, the laser light emitting element 92 is fixed by adhesive agent or the like.

Subsequently, the sub frame 22 (metal frame) is mounted in and adhesively fixed to the main frame 21 (resin frame). It takes time until adhesive force manifests after the sub frame 22 and the main frame 21 are adhesively fixed by adhesive agent. Therefore, the inclination of the sub frame 22 (metal frame), etc. are adjusted during this time period. After the adhesive fixing, the total reflection mirror 72 is mounted on the main frame 21, adjusted in the optical axis direction and then fixed by adhesive agent or the like.

Furthermore, the objective lens driving mechanism 8 is mounted in the objective lens driving mechanism mount area 209 of the main frame 21 (resin frame), positionally adjusted and then fixed by adhesive agent or the like. Then, the signal detecting light-receiving element 84 and the sensor lens 76 are mounted on the sub frame 22 (metal frame), and after these optical elements are positionally adjusted, they are fixed by adhesive agent or the like.

The present invention is not limited to the above-described embodiments, and various modifications may be made without departing from the subject matter of the present invention.

For example, the three chip resistors 111, 112, 113 are mounted on the adjusting circuit board 11 in the above embodiments, however, the number of the chip resistors 111, 112, 113 is not limited to a specific value. In short, it may be properly determined on the basis of the combination of the size of the adjusting circuit board 11 and the resistance value to be set. In this case, it is preferable that the size of the adjusting circuit board 11 on which the chip resistors 111, 112, 113 are mounted is set not to be larger than the size of the circuit board on which the variable resistor is mounted.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device comprising a laser light source, an output adjusting member for adjusting an output of laser light emitted from the laser light source and a frame for supporting the laser light source and the output adjusting member, wherein the output adjusting member has a circuit board on which a plurality of circuits each comprising short lands and chip resistors which are connected in parallel are connected to one another in series.

2. The optical head device according to claim 1, wherein the frame has a frame portion in which an objective lens for focusing the emitted laser beam to an optical recording medium and an objective lens driving mechanism for driving the objective lens are accommodated, and a fixing portion to which the output adjusting member is fixed.

3. The optical head device according to claim 1, wherein the frame comprises a metal frame containing an optical element constituting at least one of a going path through which a laser light emitted from the laser light source is led to an optical recording medium and a returning path through which reflection light from the optical recording medium is led to a photodetecting element, and a resin frame forming a frame body in which the metal frame is accommodated, and the output adjusting member is fixed to the resin frame.

4. A method of adjusting the characteristic of the optical head device according to claim 1, comprising:
determining at least one of plural series-connected short lands in accordance with the output of the laser light emitted from the laser light source; and
short-circuiting at least one of the short lands.

5. The optical head device according to claim 2, wherein the frame comprises a metal frame containing an optical element constituting at least one of a going path through which a laser light emitted from a laser light source is led to the optical recording medium and a returning path through which reflection light from the optical recording medium is led to a photodetecting element, and a resin frame forming a frame body in which the metal frame is accommodated, and an output adjusting member is fixed to the resin frame

6. A method of adjusting the characteristic of the optical head device according to claim 2, comprising:
determining at least one of plural series-connected short lands in accordance with the output of the laser light emitted from the laser light source; and
short-circuiting at least one of the short lands.

7. A method of adjusting the characteristic of the optical head device according claim 3, comprising:
determining at least one of plural series-connected short lands in accordance with the output of the laser light emitted from the laser light source; and
short-circuiting at least one of the short lands.
